(19) United States
(12) Patent Application Publication
(10) Pub. No.: US 2024/0349016 A1
(43) Pub. Date: Oct. 17, 2024

(54) SYSTEM AND METHOD FOR ASSOCIATING DIGITAL IDENTIFIERS TO A PHYSICAL LOCATION

(71) Applicant: Matchbook Data, LLC, Peachtree Corners, GA (US)

(72) Inventors: Vinod Kashyap, Dunwoody, GA (US); Kenneth S. Herbert, Georgetown, KY (US); Peter M.P. Connolly, Attleboro, MA (US); Alexander S. Porter, Sacramento, CA (US); David Moser, Broadlands, VA (US)

(21) Appl. No.: 18/638,485

(22) Filed: Apr. 17, 2024

Related U.S. Application Data
(60) Provisional application No. 63/496,614, filed on Apr. 17, 2023.

(51) Int. Cl. H04W 4/029; H04L 61/5007

(52) U.S. Cl. CPC H04W 4/029; H04L 61/5007

(57) ABSTRACT

The invention is directed towards a digital location identification system and method for the same. The system and methods may include receiving data related to network activity of a plurality of digital devices, the data having for each digital device: a digital identifier; and network access information including an IP address that the digital device accessed, and corresponding time and location information at the time of access. Also, the systems and methods may include matching, via a matching module, the digital identifier and network access information to deterministic location data representing a static location of a physical structure to create or update location identifiers. Furthermore, systems and methods may include receiving activation instructions relating to one or more of the plurality of digital identifiers. In addition, methods may include mapping the activated digital identifiers to corresponding location identifiers.

### CROSS-REFERENCE TO RELATED APPLICATIONS

This application claims priority to U.S. Provisional Application No. 63/496,614, filed on Apr. 17, 2023, which is hereby incorporated by reference in its entirety.

### FIELD OF INVENTION

The present disclosure generally relates to identifying locations of digital devices.

### BACKGROUND OF THE INVENTION

Identifying a person, such as a target consumer in a specific geographic area is beneficial to retailers or sellers of consumer goods and services. However, in locations where the person may be obscured, because, for instance, the person is inside a physical structure, obtaining meaningful information about the person challenging. Even more challenging is identifying a person as a target of interest within a specific location without compromising the individual's personally identifiable information. Improvements are needed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for location identification comprising receiving, via a client database, data related to network activity of a plurality of digital devices, the data may include for each digital device: a digital identifier; and network access information including an ip address that the digital device accessed, and corresponding time and location information at the time of access. The method also includes matching, via a matching module, the digital identifier and network access information to deterministic location data representing a static location of a physical structure to create or update location identifiers; receiving activation instructions relating to one or more of the plurality of digital identifiers, mapping the activated digital identifiers to corresponding location identifier; and sending the corresponding location identifier to the client. Other embodiments of this aspect include corresponding computer systems, apparatus, and computer programs recorded on one or more computer storage devices, each configured to perform the actions of the methods.

One general aspect includes a system for location identification may include one or more processors configured to: receive, via a client database, data related to network activity of a plurality of digital devices, the data may include for each digital device: a digital identifier; and network access information include an ip address that the digital device accessed, and corresponding time and location information at the time of access. The processor is also configured to match, via a matching module, the digital identifier and network access information to deterministic location data representing a static location of a physical structure to create or update location identifiers; receive activation instructions relating to one or more of the plurality of digital identifiers, map the activated digital identifiers to corresponding location identifiers, and send the location identifier to the client. Other embodiments of this aspect include corresponding computer systems, apparatus, and computer programs recorded on one or more computer storage devices, each configured to perform the actions of the methods.

One general aspect includes a non-transitory computer-readable medium storing a set of instructions for location identification one or more instructions that, when executed by one or more processors of a device, cause the device to: receive, via a client database, data related to network activity of a plurality of digital devices, the data may include for each digital device a digital identifier and network access information that includes an ip address that the digital device accessed, and corresponding time and location information at the time of access, where the digital identifier includes an ip address, a mobile ad id, a connected tv id, or an email address; match, via a matching module, the digital identifier and network access information to deterministic location data representing a static location of a physical structure to create or update location identifiers, the deterministic location data may include a latitude and a longitude of the physical structure; receive activation instructions relating to one or more of the plurality of digital identifiers; map the activated digital identifiers to corresponding location identifiers; and send the location identifier to the client. Other embodiments of this aspect include corresponding computer systems, apparatus, and computer programs recorded on one or more computer storage devices, each configured to perform the actions of the methods.

### BRIEF DESCRIPTION OF THE FIGURES

Having thus described embodiments of the disclosure in general terms, reference will now be made to the accompanying drawings, which are not necessarily drawn to scale, and wherein:

FIG. 1 is a block diagram of an exemplary location identification system in accordance with embodiments of the present disclosure;

FIG. 2 illustrates determining a physical location in accordance with embodiments of the present disclosure;

FIG. 3 illustrates an example location identifier in accordance with embodiments of the present disclosure;

FIGS. 4A-4B illustrate example location identifiers and aggregated location identifiers in accordance with embodiments of the present disclosure;

FIG. 5 illustrates an embedded SDK for use with location identifiers in accordance with embodiments of the present disclosure;

FIG. 6 illustrates movement of IP addresses in accordance with embodiments of the present disclosure;

FIGS. 7A-7B illustrate IP address reallocation in accordance with embodiments of the present disclosure;

FIG. 8 illustrates an example of Real Time Bidding in accordance with embodiments of the present disclosure;

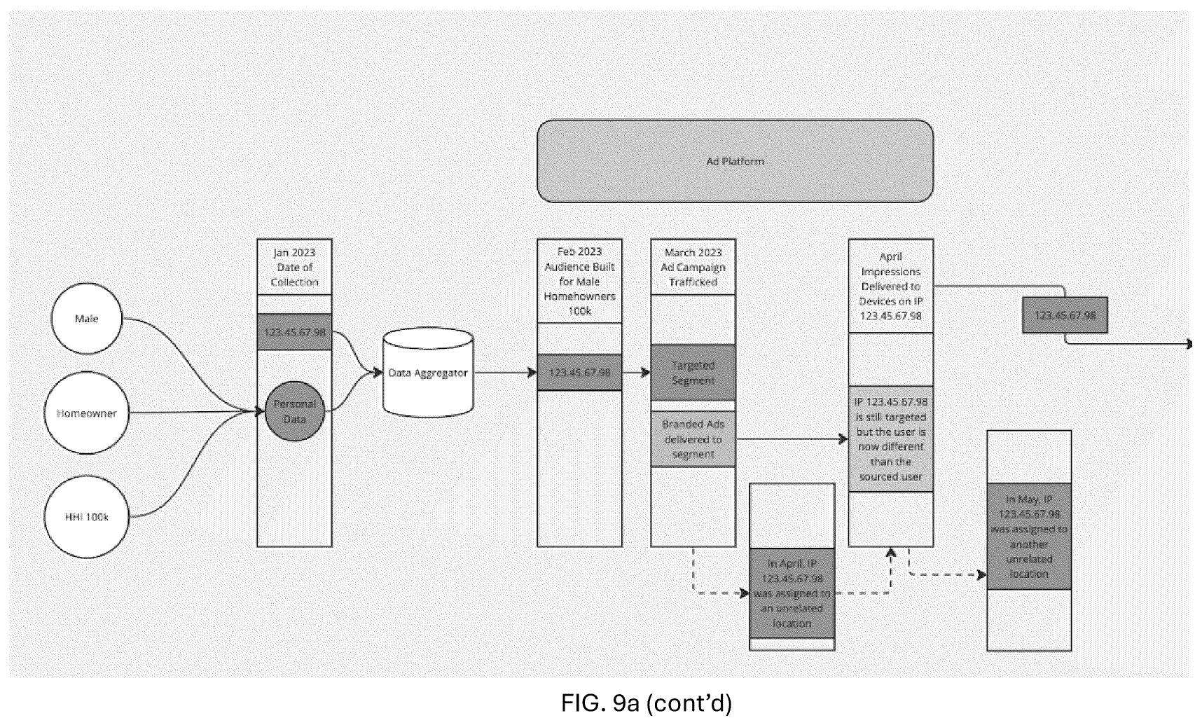

FIGS. 9A-B illustrate an example ad platform in accordance with embodiments of the present disclosure;

FIG. 10 is a flow chart illustrating the process of providing location identifiers in accordance with embodiments of the present disclosure; and

FIG. 11 illustrates a computing device as it relates to the present disclosure.

FIG. 12 illustrates an example of a targeted IP address and distance traveled over a period of days according to an aspect of the present disclosure.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Various changes, modifications, and equivalents of the methods, apparatuses, and/or systems described herein will be apparent to one of ordinary skill in the art. The sequences described herein are merely examples and are not limited to those set forth herein and may be changed as will be apparent to one of ordinary skill in the art.

In the following description, numerous specific details are set forth. However, it is to be understood that embodiments of the invention may be practiced without these specific details. In other instances, well-known methods, structures and techniques have been shown in detail in order not to obscure an understanding of this description. However, description of functions and constructions that are well known to one of ordinary skill in the art may be omitted for increased clarity and conciseness.

In the aspects described herein, the disclosure is directed towards systems and methods for associating digital identifiers with a physical location and a point in time to create aggregated location information in the form of a location identifier (sometimes referred to herein as LocID or LocationID). The systems and methods further relate to providing the aggregated location information to a user for use in consumer advertising or cybersecurity applications.

In an aspect, the location identification system is configured to utilize data collected by publishers (application creators) from devices. The information is collected through SDKs found in applications utilized on a device. The SDKs will collect device activity information and provide that, via the publisher, to the system. The device activity information includes include transactional device identification information (e.g., MAID, IFA, etc.), IP connection information of that device (i.e., which IP address did it access), location information of the device at the time of access, and the time at which the device accessed the IP address.

Once the system has this data (which can be stored in a database which aggregates the data from clients (herein client database)), the system 100 can then associate IP addresses with a given physical location. And from here, the system can also identify which devices can be associated with the physical location, and well as their active times at this location. The association of the IP address(es) and device(s), to physical location(s) and their active times at those locations, creates a location identifier that customers can utilize to send information (e.g., ad campaign or user authentication purposes) to associated devices with the location identifier. In addition, the system is configured to share multiple location identifiers with customers when overlaps of locations/IP addresses/devices occur. Given the time-spatial component of the location identifiers, the location identifier information can differ from one time to another. These and other functionalities are discussed in more detail below.

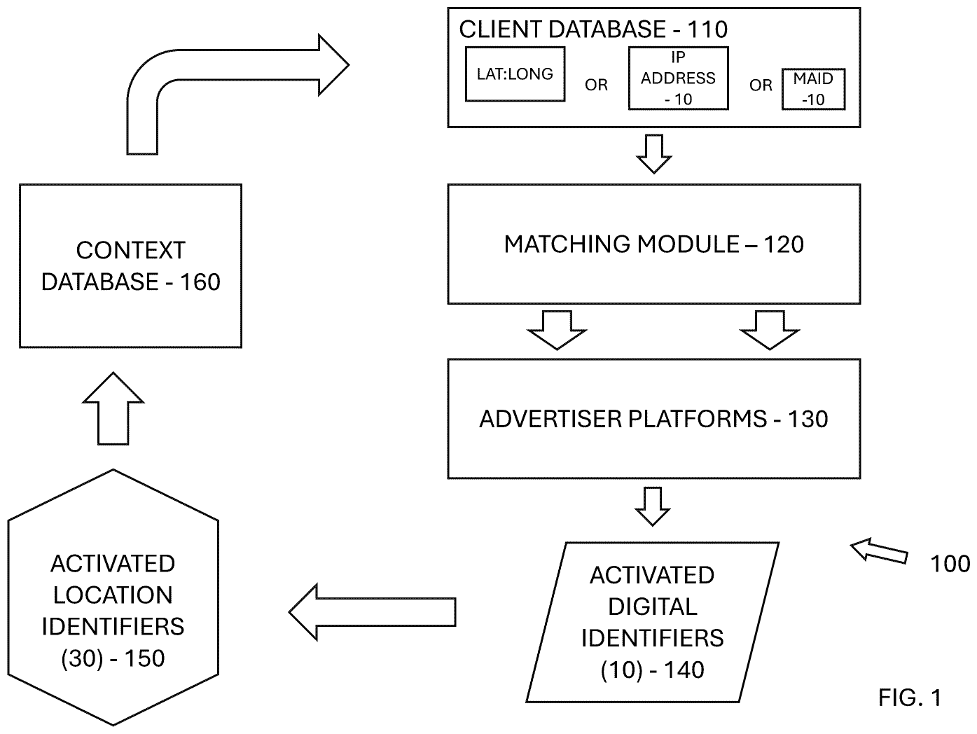

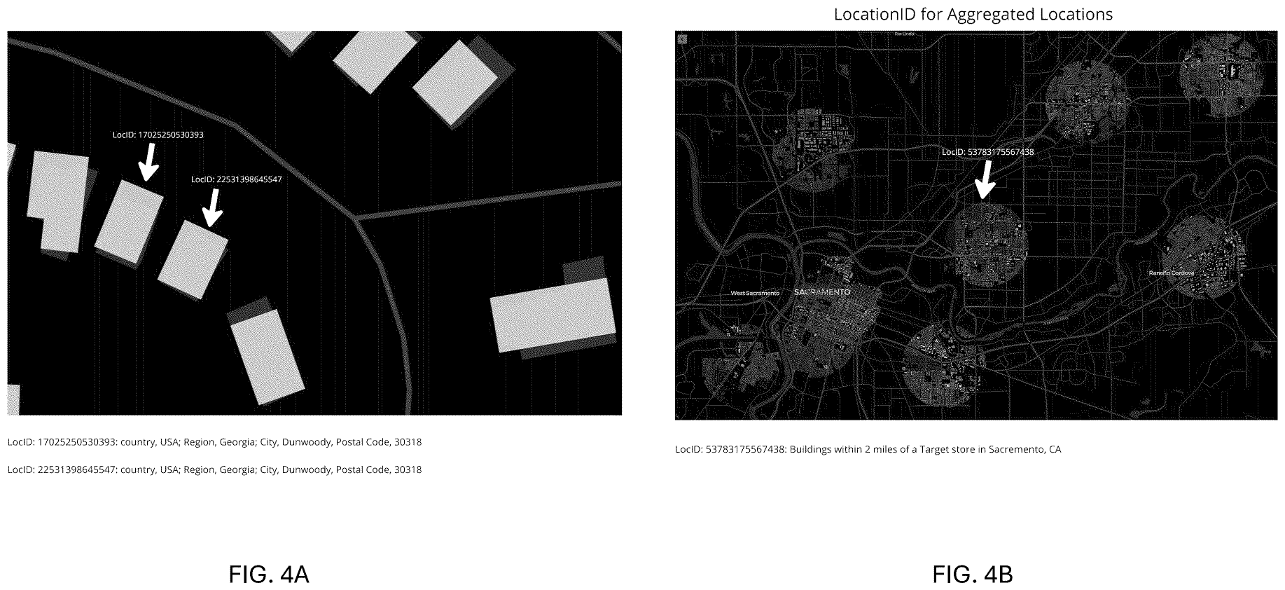

FIG. 1 illustrates an exemplary location identification system 100. The system 100 is a physical-to-digital target identification system that associates digital identifiers 10 to a most likely location at the physical structure level to produce location identifiers 30 (e.g., see FIGS. 1 and 3), discussed in more detail below. In some instances, the physical structure is a permanent structure such as a building or a set or group of buildings. The system 100 may be configured to associate digital identifiers 10 (e.g., FIG. 3) to a permanent physical structure by establishing a physical identifier 20 of the physical structure and identifying one or more digital identifiers 10 associated with the location. From this, the system 100 is configured to create a location identifier 30 that is the aggregation of the location information (i.e. physical identifier 20) and the digital identifier information (i.e. the digital identifier 10) at a given time, as shown in FIG. 3.

The system 100 is configured to receive first party data, such as location information and digital identifier information. In such aspects, a client database 110 is configured to receive as inputs location information and various digital identifiers 10 and other information collected from devices. The digital identifiers 10 identify connected devices that are mobile (e.g., smart phones) and non-mobile (e.g., connected TVs), as well as network access points (e.g., IP address). Additional information provided to the client by the devices can include, GPS/latitude and longitude associated with the device during network connection (“lat/long”), software identifiers associated with mobile devices for advertising purposes (mobile ad IDs, or MAIDs), as well as time of access of networks. A MAID may also be known as a Device ID, IDFA or Identifier for Advertising (IFA), is a unique identifier assigned to each smartphone, enabling each device to be identified. These digital identifiers (e.g., MAIDs, hashed email addresses, etc.) may be provided by a user (e.g., a client). The client database 110 is further configured to store the received client first party data.

The system 100 comprises a matching module 120 configured to associate digital identifiers 10 to their most likely location (physical identifier 20) to generate a location identifier 30. The matching module 120 is configured to map a digital identifier 10 (e.g., IP address or MAID) to a location with building-level specificity (i.e., down to a building rooftop or topmost structure level). While the physical location (i.e., the physical identifier 20) of a permanent structure typically remains static in a particular location, location of some digital identifiers 10 (e.g., IP address, MAIDs, email addresses, etc.) may change. Hence the need to have the additional identifier of a location identifier 30, which pairs a device's location at a given time at a physical location (e.g., the physical identifier 20) incorporating a spatial-time element into the system 100. In an aspect of the disclosure, commercial embodiments of the system 100 refer to the location identifier 30 as the Location ID 30. Hence, the two may be used interchangeably throughout this disclosure.

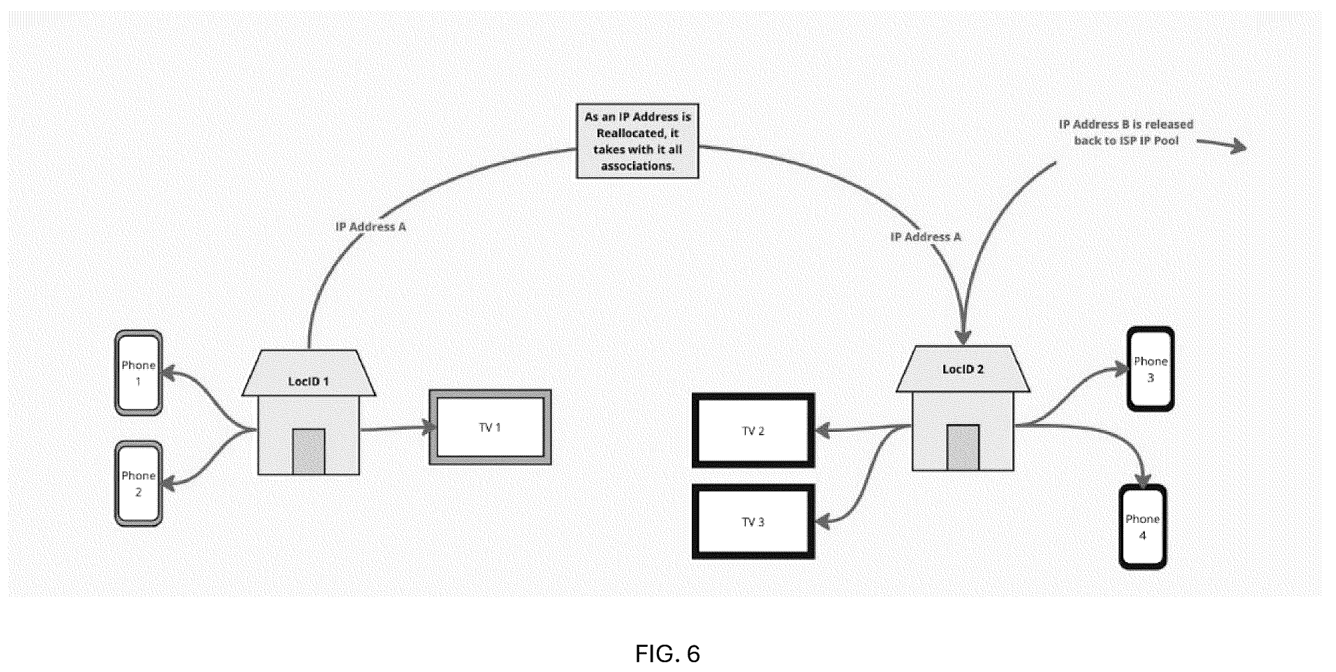

Non-mobile connected devices can have a digital identifier 10 embedded in a streaming platform such as a connected TV (CTV) or Free ad-supported television (FAST TV) platforms. For example, as shown in FIG. 5, a digital identifier Software Development Kit (SDK) can be embedded software for mobile CTV platforms or devices like Roku®, Apple TV, Android TV etc. The purpose of the SDK is to provide persistent measurement to a given building where the platform is being used when no other identifier is present. The persistent measurement capability allows the platform provider to measure where ads were served for example, and if those ads were served to the same location when they are served at a different time. Some FAST TV platforms and providers such as Tubi, Pluto TV, and others do not require users to provide login information, and are therefore are unable to provide email-based connectivity to greater data access. The system SDK provides a level of measurement capability for these types of providers.

In this aspect, upon initialization of the app by the user, the SDK will immediately be initialized. The SDK will identify the IP address connection of the device, and use an API to query for the LocationID 30 by pinging a digital identifiers database 112. This digital identifier database can be a separate database from the client database 110, or can be its own separate database 112 utilized by the system 100. The SDK will then return to the app the Location ID 30 assigned to the associated IP Address of that device. The API will also retrieve the timestamp corresponding to the activation of the device of the IP address, and any associated location information that the operating system provides for the device.

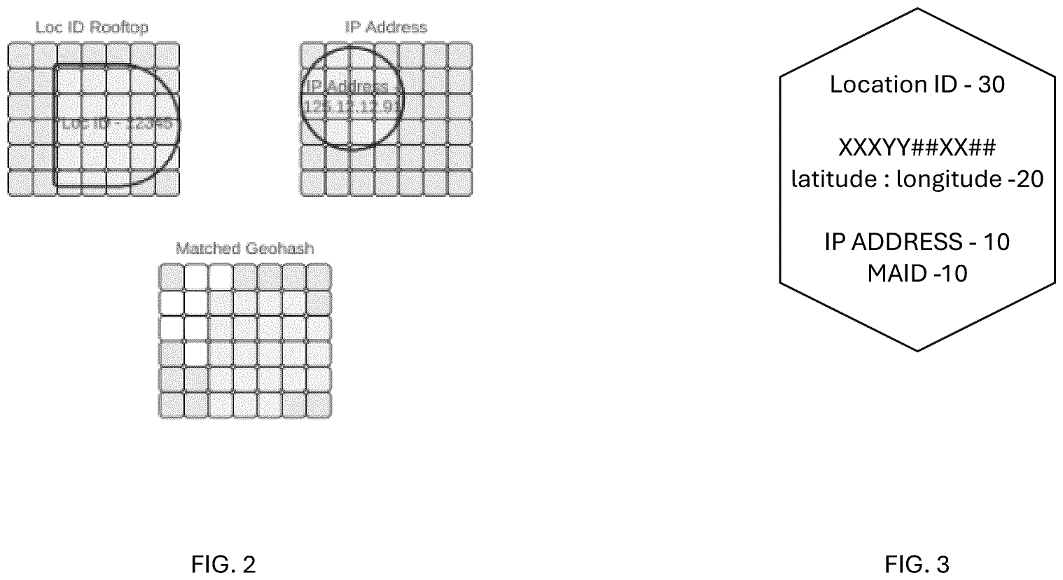

In addition to receiving client data, the system 100 is also configured to form deterministic identifiers based on non-client data. For example, a deterministic identifier can include a location identifier 20, as discussed below. The deterministic data includes a physical location for a structure, within which consumers or other targets of interest may be present. FIG. 2 illustrates determining a physical location in accordance with embodiments of the present disclosure. The system 100 is configured to capture data associated to a physical structure, rather than to an individual located inside the structure to generate a location identifier 20. As discussed herein, the location identifier 20 is a reference to a physical location. In an exemplary aspect, each location identifier 20 is configured to provide a one-to-one association with, for example, physical location information, such as a latitude and longitude (“lat/long”), that represents a structure, including buildings and the like. In other aspects, the location identifier 20 can be used to identify other permanent structures or the like. In general, the location identifier 20 identifies a structure with some level of permanence (e.g., train/bus stations, parks, etc.). That is, in most aspects, the structure is not temporary. In an aspect, each location/building is addressable within the local or regional postal code system where physical mail can be sent to that location. Once a location identifier 20 has been assigned to a given lat/long coordinate, the location identifier 20 will be persistent. In such an aspect, the location identifier 20 as mapped to certain lat/long coordinates, is permanent, and will not be changed. New location identifiers 20 can be created if new buildings or locations are identified.

As shown in FIG. 2, to determine a physical location of a structure, a polygon of the shape of the structure is approximated and used to identify the centroid of the structure. For physical structures, the distance of the IP address to the centroid of the polygon associated with the location identifier 20 polygons may be measured. An encoded (or hashed) value (e.g., geohash), representative of the central point of the spatial location is utilized. The value is then encoded (or hashed) to an alphanumeric string of 10-11 characters. In embodiments, values may be encoded or hashed up to 64 characters. Other forms of encoding, including, but not limited to, H3, S2, and Quadbin, may be used. Further, non-encoding methods can be used. For example, vectors can be used to represent each location.

As also shown in FIG. 2, an IP address has a pair of coordinates (the centroid) of where the IP address is located. The IP address also has a horizontal accuracy associated with it. This horizontal accuracy, or HA, is represented in meters and is the radius of where the IP address could be located. Thus, for example, an IP address with an HA of 100 meters could be located within 100 meters of the centroid in any direction. However, the HA can vary in value. For example, in one aspect, HA can range from 100 meters to 350 meters. Further, the HA value can be adjusted/set as desired. This radius creates a circle area and the location identifier rooftops that the circle overlaps can all be associated with the IP address. The centroid of the structure and the centroid of the area covered by the lat/long observations of the IP address are compared. The structure having a centroid nearest to the centroid of the IP address (associated with the digital identifier 10) is selected as a best location identifier 30 match. Once an IP address is associated with a physical identifier 20, then a location identifier 30 is activated/generated.

Geohashing (i.e., the public domain system for turning the globe into spatial segments of size with different level of precision (e.g., geohash 1 is ≤5,000 km×5,000 km, geohash precision 9 is ≤4.77 m×. 4.77 m)) may be used for determining the region encompassing a particular structure. For returned matches the system 100 may return any location identifier having a geohash (geohash precision 9) in common with the buffer/horizontal accuracy of a particular IP address centroid. For example, rooftops get geohashes that overlap at an overlap threshold of at least 51%. This prevents the same geohash from being in multiple rooftops. IP addresses get geohashes having a centroid that falls within the centroid's buffer/horizontal accuracy. The geohashes are then matched.

To rank the location identifiers 30 with which an IP address overlaps, the system performs a distance measure from the centroid. However, a combination of distance and the number of geohashes that are overlapped between location ID and IP address may be utilized. For example, it's possible that a small building centroid is closer by distance to the IP location than a large building centroid, but due to the building shapes, the large building may have more geohash 9 overlaps than the small building. In this case, a combination of logic would be used to determine the correct assignment.

A matched location identifier 30 may then be passed to an Advertiser PlatformAdvertiser Platform 130 (e.g., DSP,Exchange, SSP, ID Graph etc.) or other platform for activation. To this end, the system 100 can include a real-time Customer API for users that allows users to associate an input key with the desired matches. This enables a user to submit one of the four inputs (lat/long, IP address, MAID, or Spatial Index) and match it up to a digital identifier 10. In some aspects, this matching can occur in less than 50 ms. The Ad Platform 130 can then use the digital identifier 10 integration to target advertisements to the chosen location identifiers 30, activating without dependency on common digital identifiers (TP address, MAID, CTVID, etc.).

The activated digital identifiers 140 are then mapped to location identifiers 30, which are stored in a database of activated location identifiers 150, grouped by location. As discussed herein, the data associated with a given location identifier 30 are the digital identifiers 10 (i.e., network and software IDs) and the physical location information (i.e., physical identifiers such as lat/long or geo-polygon). In an aspect, the system 100 is configured to match data requested by clients based upon the three inputs associated with the location identifier 30 discussed herein: digital identifiers 10, timestamp and the location. More specifically, a timeframe, physical identification(s) and a digital identifier(s) are matched with the location identifier 30, which can then identify additional location identifiers 30 for use with, for instance, an ad campaign. The data associated with a given location identifier 30 includes the digital identifiers 10 and the location information such as lat/long. The physical identifier 20 is matched to a location identifier 30 and then matched to a digital identifier 10 (ex: lat/long to MAID to IP address). For example, a physical identifier 20 (lat/long, zipcode, physical mailing address) is provided to the system 100. The system 100 takes the physical identifier 20, and then matches, via a matching database, this physical identifier 20 to a location identifier 30. As discussed above, the location identifier 30 is also associated with digital identifiers 10. The system 100 will then provide to the user or a user-specified platform the additional location identifiers (ex: lat/long to MAID or IP address).

The system 100 is configured as a one-way data flow, whereby data does not flow in the direction of digital identifier 10 to physical location. That is, the system 100 will not reverse the flow in the direction of digital identifier 10 to physical location (ex: IP address to MAID to lat/long). Likewise, when a digital identifier 10 is provided, the system will match that digital identifier 10 to a location identifier 30 to find physical identifiers 20 (e.g., a zip code, building geo-polygon, etc.), and then provide for the campaign additional digital identifiers 10 associated with respective location identifiers 30 that include the same physical identifier(s) 20. In additional aspects, the location identifier 30 will also be supplied with additional context (e.g., Geo contest (e.g., zip code+4 digits)), which can be supplied and stored via a context database 160.

The activated location identifiers can be mapped back to the system's database to create a list 150 consisting only of the location identifiers 30 that were activated upon. Such a list can inform a user about measurement of their audience segment that successfully saw the advertisement. In another aspect, clients can receive from the system 100 a batch of activated location identifiers 150. The batching of activated location identifiers 150 can be done at a high level in order to maintain the privacy of the audience. In such aspects, clients will receive data about which location identifiers 30 were activated upon in batch format at a zip or postal code level. This can provide visibility into which locations at the postal code level performed better or worse, while still maintaining privacy of the audience.

Location identifiers 30 may be aggregated alongside MAIDs to build geospatial audiences. The system is configured to generate a collection of activated location identifiers for a particular location. The purpose of the collection of location identifiers 30 is to obfuscate digital identifiers 10 (i.e., network identifiers and software identifiers) that enable the potential to trace a location to an individual person, while at the same time reaching a targeted audience. Thus, once location identifiers 30 have been identified, the system 100 is configured to obfuscate identifiers assigned to an IP address, where the assignment of a location identifier 30 is derived from a combination of device observations, IP addresses, and connection times. The system 100 determines the most likely location of relevance (business, home, retail or leisure, etc.), and the determined most likely location may be used to help enrich the location identifier 30 with additional data points such as location identifier to Identifier for Advertising (IFA)(e.g. 01234567-89ABCDEF-GH01-23456789ABCD), or other devices such as connected TV (CTV) devices. For instance, location observations (e.g., IP Address, Latitude & Longitude, HA, etc.) are collected from various sources (e.g., mobile devices, CTV, and the like), enabling IFAs to be captured at an early stage in the process. As with IP addresses and MAIDs, IFAs may be linked to a location identifier 30. This allows the system 100 to utilize geospatial data (census demographics, neighborhood affluence, school district ratings) and apply those audiences to IFA identifiers for each location identifier 30. With this practice, IFAs will include geospatial attributes, which can be converted into segments for other IFA-based targeting.

The system 100 may be configured as a one-to-many targeting solution that is optimized for privacy and reach. As mentioned herein, the target location may be a permanent physical structure having a number of potential target consumers inside. In the context of advertising, targeting buildings is analogous to using a billboard or other visual display (Out-Of-Home), or linear television advertising in that an advertisement may be viewed by a consumer of this type of media without knowing or identifying the consumer's identity. In such embodiments, the location identifier 30 is configured as a one-to-many identifier. That is, a plurality of identifiers, such as digital identifiers 10, can be associated with or reference the location identifier 30. For example, each digital identifier 10 aggregated within a location identifier 30 can be a reference to an IP address, Mobile AD ID (MAID), CTV identifiers, and various other identifiers. A MAID may also be known as a Device ID, IDFA or Identifier for Advertising (IFA), is a unique identifier assigned to each smartphone, enabling each device to be identified. In an aspect, when IP addresses, MAIDs, or any other identifiers associated with a location identifier change, the change is referenced and recorded as associated with that location identifier 30. The historic view of these changes can be as far back as data is available, or up to a selected amount of time, which can be determined by users of the system, or requested by advertisers.

In an aspect, one location identifier 30 may be fragmented into multiple nested “children” or sub-location identifiers. That is, there may be a location that has many other identifiable locations within it. For example, an apartment building can have a location identifier 30, with each apartment unit within the building having a child location identifier associated with the unit, with multiple IP addresses present in the location identifier.

The system 100 may be configured as a many-to-many targeting solution that is optimized for privacy and reach. Within the system, a many-to-many relationship may exist between IP address and location identifiers 30 as described herein. This is partially due to GPS accuracy and observation point variability, but also because the system 100 is configured to provide transparency in margin of error. To account for this, an IP address can have many location identifier matches in densely populated areas, with the system 100 utilizing a defined rank of match performance. For instance, if an IP-based geolocation system (e.g., a Horizontal Accuracy system) captures 20 buildings, the closest match may be ranked 1 and the lowest match may be ranked 20. The system 100 is configured to return a selection of highest ranked matches/highest confidence score for efficiency. This also helps to preserve privacy because, while the system 100 may return a strong recommendation, the system does not provide a deterministic IP address < > location identifier correlation. Along with location identifier-enriched metadata, the system provides rank/confidence scores for users to interpret independently.

In an aspect, a location identifier 30 is created for a given location when deterministic data about the location is received, as well as the identifiers associated with that location observation. Each observation is considered only if a precise lat/long is present from the data received. In an aspect, the lat/long, horizontal accuracy, time stamp, IP address, and digital identifier all are used to define the location as a new location. In an aspect, the new location for a location identifier 30 is further determined using only a fixed Wi-Fi connection as mobile IPs (those derived from cell towers) are filtered out since the same identifiers (TP addresses, MAIDs, etc.) can represent a large area.

In another aspect, the location accuracy for the location identifier 30 can be determined as well. For example, each location identifier can be confirmed from a cluster of at least a certain number (X) of observations from mobile devices where the median absolute deviation (MAD) distance between lat/longs is no greater than Y meters. A mobile device observation may be defined as any data point that influences the derived lat/long location of the IP address, which combines GPS latitude, longitude, and IP Address to influence the final location of an IP address. The system 100 is configured to obtain the following fields in a given observation: Lat/Long derived from GPS sensor in the mobile device, time stamp, IP address, and Horizontal Accuracy, when available.

In another aspect, the system 100 is further equipped to handle location size variances associated with each location identifier 30. Location sizes associated with buildings can vary in size. For example, an office building may be one size and a townhome or a single family home may be another size. The system 100 uses machine learning techniques and various algorithms known in the art to determine the location identifier 30 association with different locations.

In another aspect, a location identifier database can include general contextual information about that location at an aggregated level, including, but not limited to, census data associated with the location. However, the location identifier database can be further configured to not identify the location, or the persons within the location, with any specificity that would enable traceability to that person. Along the same lines, the system 100 can be configured to further ensure privacy of end users associated with the other identifiers. For example, the system 100 may receive identifiers from opted-in mobile devices. However, if a mobile app user decides to opt out later on, or creates a deletion request, the system 100 is configured to remove the respective identifier data to prevent the system from tracing the identifier to the user.

The system 100 employs geo-aggregation to form at least part of the location identifier. A location identifier is assigned to a fixed location, not an address or resident/occupant/inhabitant. According to embodiments of the disclosure, at least a portion of the location identifier is most commonly representative of a building, but is also capable of being a custom space, such as a postal code or a customized area (e.g., all buildings within 5 km of an identified point of sale (POS)). In each instance, the location identifier is an aggregate of occupants and is thus an aggregated location identifier.

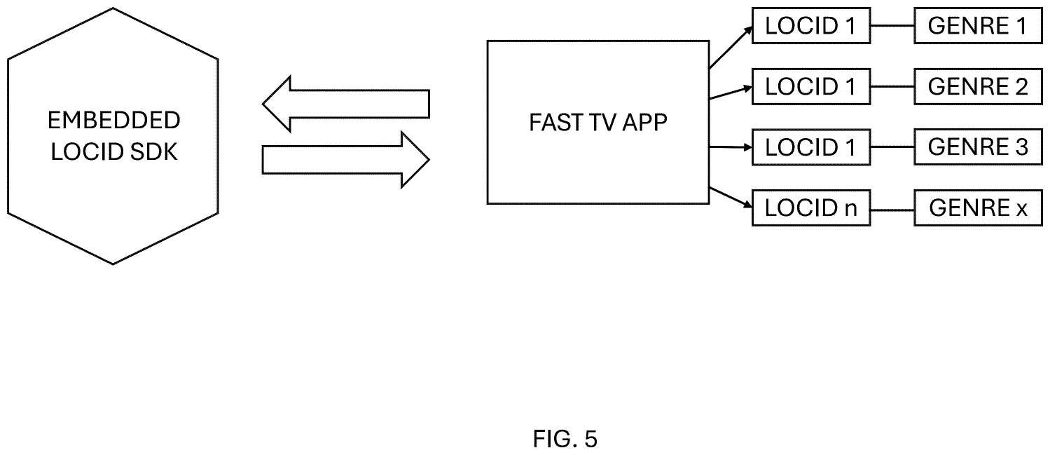

FIGS. 4A-4B illustrate example location identifiers and aggregated location identifiers in accordance with embodiments of the present disclosure. The terms location identifier and aggregated location identifier may refer to two distinct levels of detail that differ only in a business context, yet can be represented as the same identifier. The location identifier value returned to a user can represent a singular LocationID or a collective LocationID. The following table is an example that demonstrates that a singular-level location identifier (derived from observations) can be distinct, while an aggregated location identifier can represent a shared arbitrary location identifier context (e.g. state, postal code, building size etc) that is only known to transactional users. For instance, Aggregated LocationID 123456999 represents some common value between the location identifier, but that common value is entirely flexible and open-ended in design.

TABLE 1

| IP Address | LocationID | Aggregated LocationID |
|---|---|---|
| 67.181.245.166 | 123456789 | 123456999 |
| 67.181.245.167 | 123456780 | 123456999 |

* All values are arbitrary

While the system may determine a precise location of a building, the precise location is not shared to any customer. In this case, users will be able to request the location (country, region, city, postal code, etc.) of a location identifier using, for instance, an API.

Each location identifier has a one-to-one association with a latitude and longitude that represents a fixed physical location (the physical identifier), abstractly tied to a structure such as a building. Each location identifier represents a building in its entirety, not, for instance, a unit within the building or an individual household. To this end, multifamily buildings or multi-business buildings will have location identifiers shared by different MAIDs and/or IFAs. In some aspects, the system 100 does not need to nor does it ingest or retain physical mailing addresses, and mailing address information is not utilized to derive location identifiers. In some aspect, mailing address information can be transformed into lat/long data.

Location identifiers 30 are persistent relative to their respective geo reference points once created. Location identifiers 30 are predetermined globally, and their existence is independent of a match to the IP. Unusable location identifiers may exist, in that they are not matched to an IP address. Further, IP addresses and MAIDs may geospatially overlap with many location identifiers 30, and the system provides match rankings to users. A single IP address may have potentially hundreds of matching location identifiers, with some having much stronger signals than others. While the system 100 does not retain the identifiers for a given IP address, users will be able to easily aggregate digital identifiers 10, including hashed email IDs (e.g., LiveRamp's UID and RampID) to a single location identifier 30.

For business accounts, (such as Retail user accounts), the system can be used to map a consumer's account (e.g., via their online shopping IP Address) to a location identifier. From there, the system can build a segment of location identifiers relevant to that retail user, which can be associated by the user to that account ID. This provides a more stable experience for targeting or suppressing existing consumers.

The hyperlocal IP address database and related location identifier are aggregate information based on many devices. Data filtering may be performed at ingestion, i.e., upon receipt of the client data. IP addresses may be withheld from users if they do not meet a certain threshold of distinct devices. The system may be configured to validate that a minimum number of activated location identifiers have been produced after the filtering.

An internal location identifier exists as an immutable identifier, and is not exposed to an end user (e.g., a client, customer, etc.). The value that is exposed to user is a real-time encoded value which cannot be decoded by the user. Each user has a unique encoding, or a Client LocationID (CLOC), so the client facing value encoded for two clients will be different for each client. Users may be provided with the ability to perform translations using the system, to ensure a location identifier can be transacted between vetted participants. CLOCs have a time component, comparable to a hashed salt, which a client may access using the system. Thus, an exposed location identifier value does not reveal or compromise underlying data, reducing the threat of disclosing personal consumer information, because the location identifier will be unable to be matched as the time component attached to the location identifier causes the location identifier to quickly become stale. The Internal LocID is the geohash centroid, and then CLOCs are the encoded version of the ‘public locID’. Each client may receive a different CLOCs for the same building (root LocID). Therefore, there may be several LocID references (CLOCs) to one LocID. With this, the CLOC is the transaction layer, i.e., the location identifier which is targeted in segments, or resolved to a geolocation.

In embodiments, a user (e.g., a company or other end-user) can receive a CLOC that is customized or personalized. The system is configured to encode the location identifier with an additional encoding value (e.g., api key, client ID, etc.) and generate a unique CLOC for the user. Each user may receive a unique CLOC, as requested. The system is configured to predictably encode the CLOCs, and maintains a record of CLOC to location identifier mappings (e.g., ethereally or in as stored data set or database). Maintaining a database of all mappings enables the system to create or map location identifiers to multiple CLOCs, as needed or requested.

The system is also configured to provide a rolling CLOC for users. That is, from time to time the CLOC will be rotated to a different unique ID, however, keeping the same relationship to the root location identifier. To update or modify a CLOC, based, for instance, on time, the system is configured to update information encoded into the CLOC via an encoding process (e.g., through a run_dt instruction), and regenerate the CLOC for the user. However, the system may continue to maintain one or more previous CLOCs as well.

In another aspect, the system is configured to retarget consumers using digital identifiers that were not activated. For example, users can use the measurement information about location identifiers and their respective performance and only focus on those location identifiers and retarget an audience on the same or a different platform. In an aspect, the system is configured for integration with a plurality of platforms that allow system users the ability to use the appropriate location identifiers as the input this time and choose the appropriate identifiers within those location identifiers and target them for advertising activation.

Further, along the same lines, the system is configured to address incorrect locations for location identifiers. Any locations that are deemed to be incorrect after more data is received can be rectified through a process by which imprecise location identifiers are merged. Likewise, locations can evolve over time. For instances when people move from one house to another, and move their physical CTV devices with them, the CTV will be assigned to a new location identifier, and the old location identifier will be updated to remove the CTV.

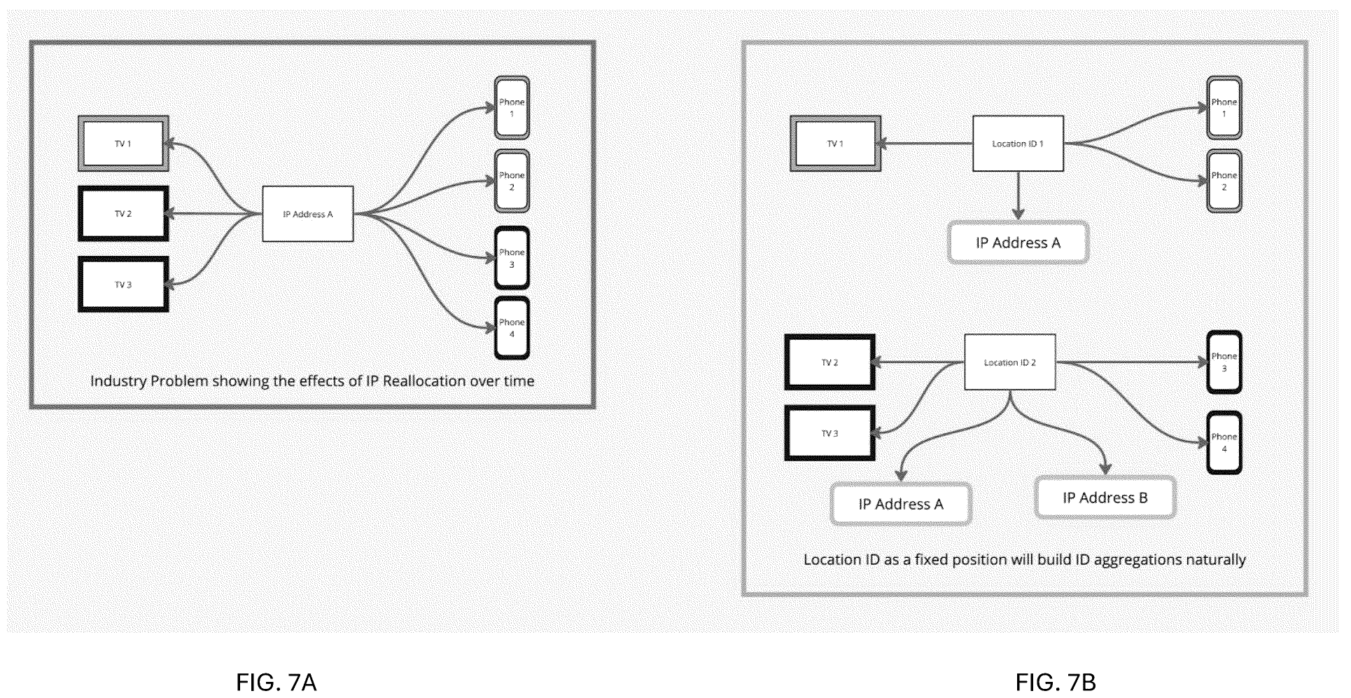

FIG. 6 illustrates movement of IP addresses in accordance with embodiments of the present disclosure. When IP addresses, MAIDs, or any other digital identifiers associated with a location identifier change to a different location, that change is referenced and recorded as associated with that location identifier. The historic view of these changes can be as far back as data is available, or up to the amount the business decides to cut off at. The effect of this is an observation over time is the ability to distinguish between device movement (e.g. A known CTV moves to a new house) and ISP reallocation of the IP (where the IP address moves to a new house, but the known CTV doesn't move to a new house). Therefore, each location identifier shows a time series of identifiers that were attributed by the system at its location.

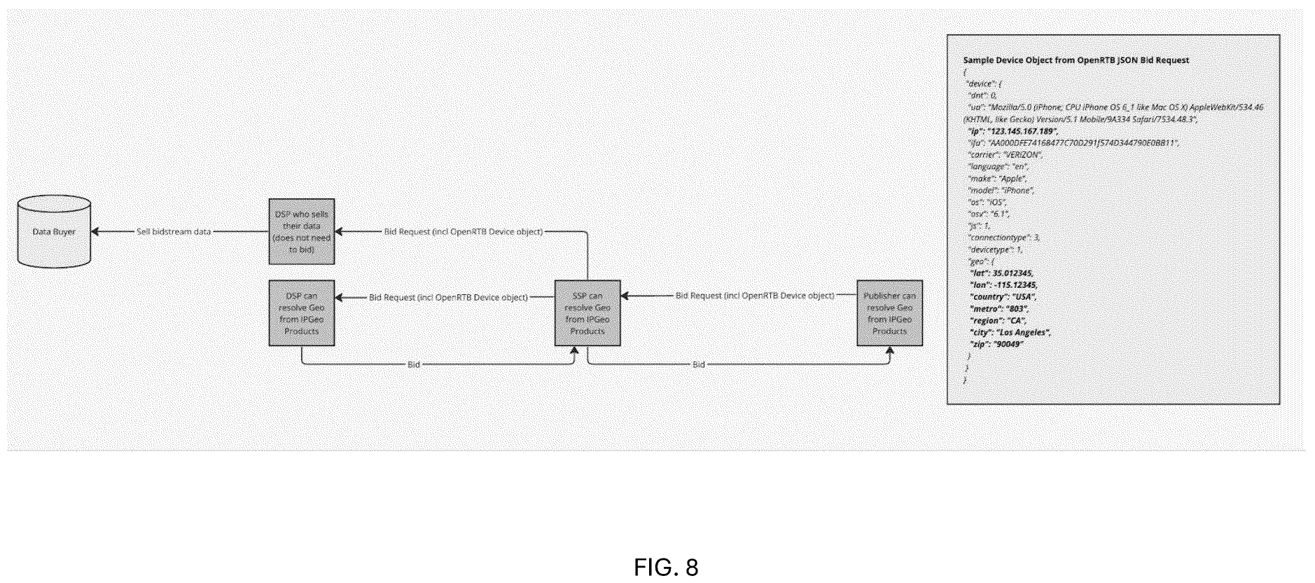

Continuing with the example in FIG. 6, FIG. 7A further illustrates the scenario in which a single IP has moved between houses (above) and after the transition it is now a container for all devices it has been observed against. For devices, over time the identifiers will become aggregated to an IP address. This creates blended views that group together too many devices from different people. FIG. 7B illustrates a scenario in which a location identifier is static and the IP address does move. Location ID has recorded timeframes in which each IP was the IP address of the location, and with this the data remains separated correctly.

The totality of singular location identifiers pre-exists IP address assignments at a static global scale. Meaning a location identifier may be assigned for structure and a group of IP addresses at a specific lat/long even if at the time no identifiers are available or have been produced for that particular location. Using the location determined for the IP address, all location identifiers are mapped to an IP address where there is a geospatial overlap with the IP's horizontal accuracy.

Location identifiers 30 are configured to obfuscate underlying IP address information when the location identifier is transacted on (i.e., uses in an ad campaign) or transferred between clients for the purpose of data minimization and ensuring IP address confidentiality, so that this type of personal information is not accidentally shared without knowledge. The system 100 prevents this type of data leak by converting the IP address into an obfuscated digital identifier at the organization before it leaves their respective data warehouse.

The system is configured to provide location identifier enrichment. A location identifier 30 may be enriched, via a context database 160, with general contextual information about a respective location at an aggregated level, such as census or demographic data associated with the location without identifying the location or the persons who may be within the specified location with any specificity that would enable traceability to that person. To this end, the location identifier serves as a vehicle for other contextual data to be delivered to a client that relates to the location identifier. For example, proximity to the nearest grocery store, purchase behavior probability based on other data such as “likely to buy beach outfits vs mountain gear” etc. This is similar to other behavioral identifiers, however different in its assignment to a group of people associated to a building or to a postal code vs where other identifiers associate this type of purchase affinity to a person.

By leveraging location identifiers 30 as an intermediary between a plurality of MAIDs, a MAID can be submitted for enrichment, returning on or more MAIDs determined to be associated with the input MAID, where a common location identifier exists. By further leveraging this intermediary functionality of a location identifier between a plurality of MAIDs, the location identifier can be submitted for enrichment, returning one or more MAIDs determined to be associated with the input location identifier.

For every location identifier 30, resolutions are provided for location information such as country, region, city, postal code, etc., and as-needed, privacy-safe intra-postal resolutions. A location identifier represents a location without filtration to size. The location identifier can represent an office building or house, or a postal code, however, no strict determination of these values is calculated.

The system is configured to generate aggregated location identifier values internally mapped to all location identifiers with common contexts. This may be advantageous for instances where clients require compressed data aggregations. For example, 10 million distinct location identifiers may be represented as a single aggregated location identifier, where the common context is that they are all within 5 km of a location of interest (e.g., given retail brand, restaurant, etc.). In this use case, the context is only relevant during generation, and it is not shared publicly.

The system 100 is configured to ensure proper data alignment. In many platforms, data becomes ‘stale’ after a period of time when it is considered to likely be out of date. With location identifiers 30, the system is configured to manage a temporal timeline and, using location identifiers as a proxy, older records may be aligned to new records. For instance, one MAID with multiple IPs over the course of a year may be interpreted as 1 MAID and two locations. Location identifiers 30 may allow users to understand if this is movement, or if it is IP reallocation without physical movement. In this case, the system is configured to assist users utilize data that may otherwise be considered stale.

The system 100 is configured to provide attribution feedback for a particular action related to use of an activated location identifier. Attribution as a form of measurement requires a single entity to compare exposure logs and action logs (visits, conversions, etc) to determine the likelihood that an ad exposure resulted in a desired behavior. In CTV applications, a disconnect may exist between the television and the browsing platforms, which may be significant. The system leverages the ability of location identifiers to provide connectivity to bridge devices by more than just IP address, to help determine if in-fact a CTV ad resulted in a desired action.

When clients activate a location identifier 30, for use in, for instance, an ad campaign, the client may insert a location identifier pixel within, for instance the digital media creative. When the inserted pixel is executed by an application, the system 100 is configured to capture the location identifier 30 that was activated for measurement, analytics and billing purposes.

Clients may receive data about which location identifiers 30 were activated in batch format. The batching of location identifiers will be at a zip or postal code level. This will provide visibility into which locations at the postal code level performed better or worse. This also ensures privacy by creating a many to many relationship. This type of deployment will be the primary mechanism of delivering data.

Clients can use IP addresses to resolve client location identifiers (CLOCs). This functionality may be a streamlined input/output function, operating in a low-latency environment intended for environments that transact data in real-time.

The system API serves as a mechanism for Publishers (Tubi, Pluto, Hulu etc) to resolve viewership IP Addresses to the Publisher's CLOC, and add the CLOC to their ID Graph before sending the CLOC to Buyers (DSP,Exchange, SSP) via OpenRTBbidstream. The system 100 comprises an API with two features and two client endpoints, e.g., for Publisher and Buyer. The distinction here is that for the Publisher, the location identifier 30 is encoded to their CLOC. For the Buyer, the API enables decoding. That is, a system API serves as a mechanism for Buyers to decode the Publisher CLOC to a recognizable location identifier for targeting purposes.

The system is configured with support for use with Bidstream, using the OpenRTB framework. RTB stands for Real-Time Bidding, which is the automated process of automated ad delivery, specifically referencing the decisions made by ad servers in real time. IP-based geotargeting is possible so long as all parties are able to share and enrich IP Addresses. If at any point, an IP address becomes truncated (e.g. COPPA) or obfuscated, the enrichment process to identify the geographic location will be broken. For clients who wish to not pass IP addresses, or those who cannot, the system serves as a stable replacement, providing the ability to resolve geolocation without the risks associated with IP Address.

For campaigns with a geotargeting component, an OpenRTB geo object must be fully composed. This can be accomplished via, for instance, IPGeoscraping or using an API. In the API context, a device with access to user registration or location data can provide API access to postal code, and the client can populate geo components from that. However, this technique is less frequently used as it requires detailed user accounts including personally identifiable information.

Outside of walled gardens, OpenRTB is the common specification defined by the Interactive Advertising Bureau (IAB). In OpenRTB, everything relevant about the ad opportunity being sold (e.g. commercial break, commonly called inventory) is defined—the media accepted, the device type, the content classifications, the identity and the geolocation. Within the scope of identity, IFAs are most commonly seen, but a section exists specifically for user identifiers, and it is extensible. This is where the location identifier will be passed through, using the existing framework.

When a location identifier is passed as an extension identifier, it may be one of many targeted parameters for any number of campaigns. In the case above, one campaign targeting a single aggregated location identifier is comparable to one campaign targeting 10 million distinct LocIDs, without the extra overhead of handling large segments. An example definition may be:
User.ext.eids[0].source
   User.ext.eids[0].uids[0].id
   User.ext.eids[0].uids[0].atype

Using this definition, a buyer can easily parse our data for real-time decisioning:

```
  “user”: {
    “id”: “abcdefg”,
    “buyerid”: “xxx”,
    “ext”: {
        “eids”: [
          {
            “source”: “locationid.digitalenvoy.net”,
            “uids”: [
              {
                “id”: “3DH93Z84A08B32C28D94E0FG438”,
                “atype”: 5678910
              }
            ]
          }]
      }
}
```

The ability to pass location identifiers in this format is critical because this capability is already used for identifiers. Clients need only leverage the very minimal standardized process of sending identifiers to bidders during RTB. This enables a buyer to target inventory using a location identifier rather than an IP address.

Thus, the system does not require exposure of user account/personal information, nor does it require IP transmission. The system may serve as its own index against a location, because every location identifier has a consistent geolocation context built into the polygon associations. Therefore, campaigns can target location identifiers based on a postal code, city, region, or country. The campaigns can also measure outcomes later as location identifiers stay consistent even if IP addresses assigned to buildings change, resulting in a consistent measurement layer.

FIG. 7 illustrates an example bid request using location identifiers to helps prevent IPgeo scraping from a bid stream. There are no regulations defining DSPs, and when a seller puts inventory up for sale, the Seller shares info with all participants, and their partners indirectly. Any entity can be a buyer, so long as the ad server can accept a bid request and respond with a standardized bid (typically OpenRTB). A common practice is for buying parties to utilize the shared data for purposes other than Bidding. FIG. 7 illustrates an exemplary process:
1. A seller (Publisher Ad Server or SSP) can utilize IPGeo to resolve IP to Geo breakdown.
2. The Bid Request is built, containing both the IP and the breakdown
3. The request is then sent to all bidders (SSP,Exchange,DSP,Other)
4. The bidders will process the request, record important information about the inventory
5. The bidders will deliver ads, and those impressions will be associated with the corresponding bid request.
6. The bidders can then build an entire mapping of IP>Geo, without needing to license an IPGeo product at all.
7. Note: OpenRTB also has a Geo Classification that labels Geo by provider (NetAcuity (Digital Element), MaxMind, Neustar, and IP2Location). This may enable a user to build our IP Geo associations for seen inventory.

In order to be used, LocationID in the form of a Seller's CLOC must be translated by the Buyer into their CLOC,and only Customers have the capabilities to translate it. As LocationID remains obfuscated in the OpenRTB server to server transaction, anyone capturing the record who is not our user will be unable to resolve the LocationID to anything meaningful. They could see IFA+LocationID, or IP+LocationID, but we retain the encoding control, and we can control the ID refresh rate which invalidates the scraped associations.

The system may provide a “most recent” indicator associated with the location identifier. This enables a user to resolve only the most recent location ID, regardless of the physical location, while adding context to the age of the record. This may be useful when graphing location identifier values to user records in a graph.

In this case, the user can input the ip_address and a max record age. The system is configured to return the most recent location ID, and the age, filtered by the maximum age:

```
Request
  {
    “method”: “GET”,
    “url”: “https://locationid.matchbook.de/recent”,
    “params”: {
        “ip_address”: “YOUR_IP_ADDRESS”,
    “age_limit”:“30”
    }
  }
Response
  {
    “ip_address”: “YOUR_IP_ADDRESS”,
      “LocationID”: 123456,
    “age_days” : 12
  }
```

### Dataset

| IP Address | LocationID | Build Date |
|---|---|---|
| 1.2.3.4 | 3945829282903 | “2024 Feb. 28” |

The system may be configured to provide a time bound API request. A time bound API request enables a user to resolve multiple periods of time, which may be particularly helpful for mapping out an IP address over time, such as when performing data matches across broad spans of time. In this scenario, a user may input one IP Address and the system returns one or more CLOCs for the specified timeframe. Users may then perform multi-party matches on the CLOCs.

In this case, the user can input the ip_address, a start date and an end date. The system returns each building and location ID:

```
{
  “method”: “GET”,
  “url”: “https://locationid.matchbook.de/timebands”,
  “params”: {
    “ip_address”: “YOUR_IP_ADDRESS”,
    “begin_date”: “YYYY-MM-DD”,
    “end_date”: “YYYY-MM-DD”
  }
}
{
  “ip_address”: “YOUR_IP_ADDRESS”,
  “begin_date”: “YYYY-MM-DD”,
  “end_date”: “YYYY-MM-DD”,
  “builds”: [
    {
      “date”: “YYYY-MM-DD”,
      “LocationID”: 123456
    },
    {
      “date”: “YYYY-MM-DD”,
      “LocationID”: 45678
    },
    {
      “date”: “YYYY-MM-DD”,
      “LocationID”: 5678910
    }
  ]
}
```

### Dataset

| IP Address | LocationID | Build Date |
|---|---|---|
| 1.2.3.4 | 3945829282903 | “2024 Feb. 28” |
| 1.2.3.4 | 2923039303039 | “2024 Mar. 15” |

Examples of commercial applications of LocationID include identifying the location of anonymous internet traffic, or authenticating known traffic against a geolocation based on the device's IP address. AdTech and cybersecurity make intentional decisions using information they have available. Whether it is to deliver an ad or block a connection, the notion of identity is important. When an IP address is reallocated, previously gathered insights become stale, and data not known to be stale will generate unintentional results. In AdTech this could range from consistently placing ads to the right geolocation, and being able to measure if the same end points (e.g., end user) saw the ads over time. In Cybersecurity, the applications is knowing is authenticating a user based on the geolocation of the LocID even if the IP address changes.

The system has several use cases that may help improve cybersecurity by improving threat detection, and forensic capability of historic data associated with a digital crime that has already occurred. In cybersecurity, if the IP address is reallocated without observation of geospatial relevance, the suspect behavior of one user might be migrated to the new user of the IP address.

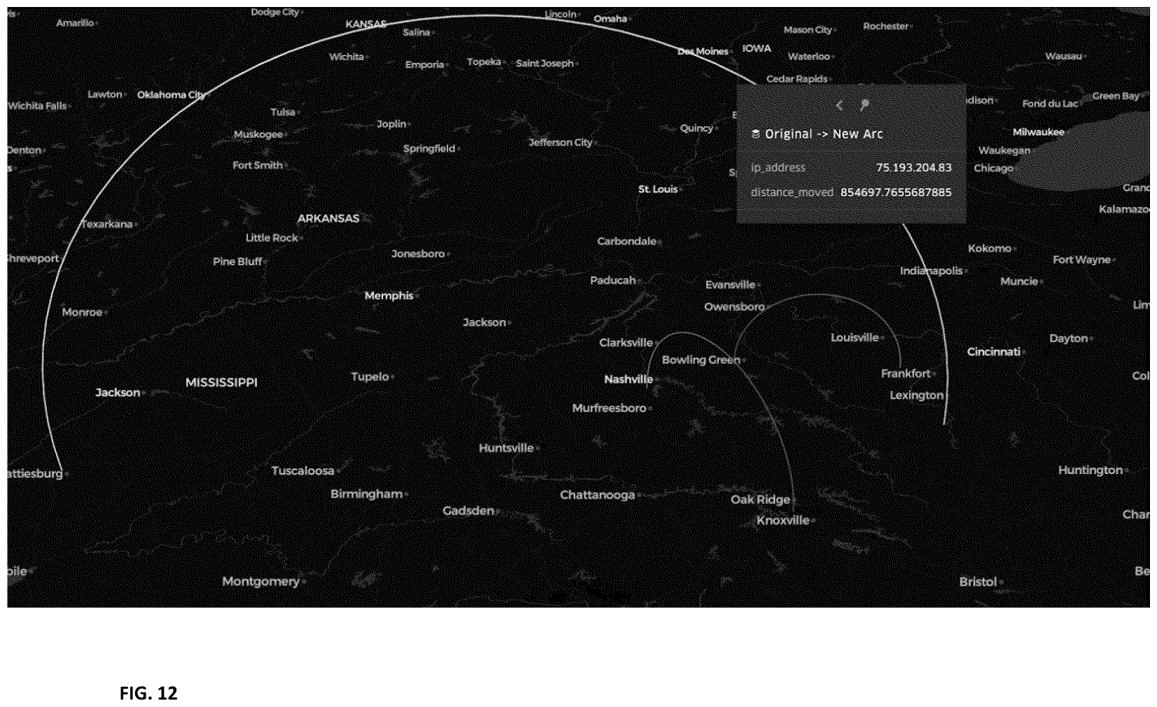

Within AdTech, targeting of IP addresses within one demographic will be applied to an unknown demographic without any indication of IP address mobility. For example, as shown in FIG. 12, a given IP address can be targeted without concern regarding its actual location over a given time frame (e.g., 30), even if they move beyond their region.

AdTech platforms are based on explicit decisioning, which includes determining how targeting works and the impact of volatility. Targeting is a boolean logic using only include/exclude statements, and where an IP address is targeted, the list is based on sourced IPs (e.g. audience data segments) or retargeting (intra-campaign delivery against recent users). In both cases, an IP address will exist as one IP address amongst many.

In an aspect, the system enables advertisers to reach a desired target audience, without specifically identifying targeted individuals. Instead, the system relies on determining an individual's or target audience's location as context, allowing advertising to be done effectively while obfuscating certain details regarding the individuals within the location.

The system can be utilized for online advertisements. In such aspects, users may provide first party data such as lat/long data of a target group, such as their target consumer base, or IP addresses from their website traffic, or MAIDs from applications associated with the user or otherwise provided to the user. In other aspects, users can also provide location based indexes. For example, users can also provide geospatial indices (e.g., Uber's H3 Index or GeoHash) at various levels of resolution. In such aspects, the level of resolution can be limited to avoid a level of granularity to ensure privacy. For example, with respect to Uber's H3 Index, the system can be limited to go with a resolution no more accurate than R8. In addition, other spatial indices like postal code or zip code can be utilized for targeting audiences.

In an aspect, the system can also be configured to create a location associated with an audience. In such aspects, input data from a user is used to match the appropriate location identifier. For example, the lat/long of a user is matched with a location identifier if a given location identifier is present at the given location, as it is possible that a user's location may not be matched with the location identifier database. All matched location identifiers can then be used to target the audience on behalf of the user using the identifiers available in those location identifiers. For example, if the user is targeting CTV audiences via IP addresses, the lat/long information relating to a target consumer base is matched to the location identifier. Then the location identifier is used to target the IP addresses associated with that location identifiers.

In an aspect, the system can be integrated with other platforms utilized by users. For example, platforms like TradeDesk, Amobee and others provide third party audience creators ways to use their platform for targeting audiences with an API integration. The API allows for identifiers from companies that create audiences to push their audiences via the API using the identifiers for those audiences. In such aspects, the location identifier system is configured to integrate with these APIs so that the location identifier can be pushed to these types of platforms in order to activate the audiences provided by the system's users. In an aspect, the targeted and activated Identifiers are shared with the system using the same integration.

### Examples

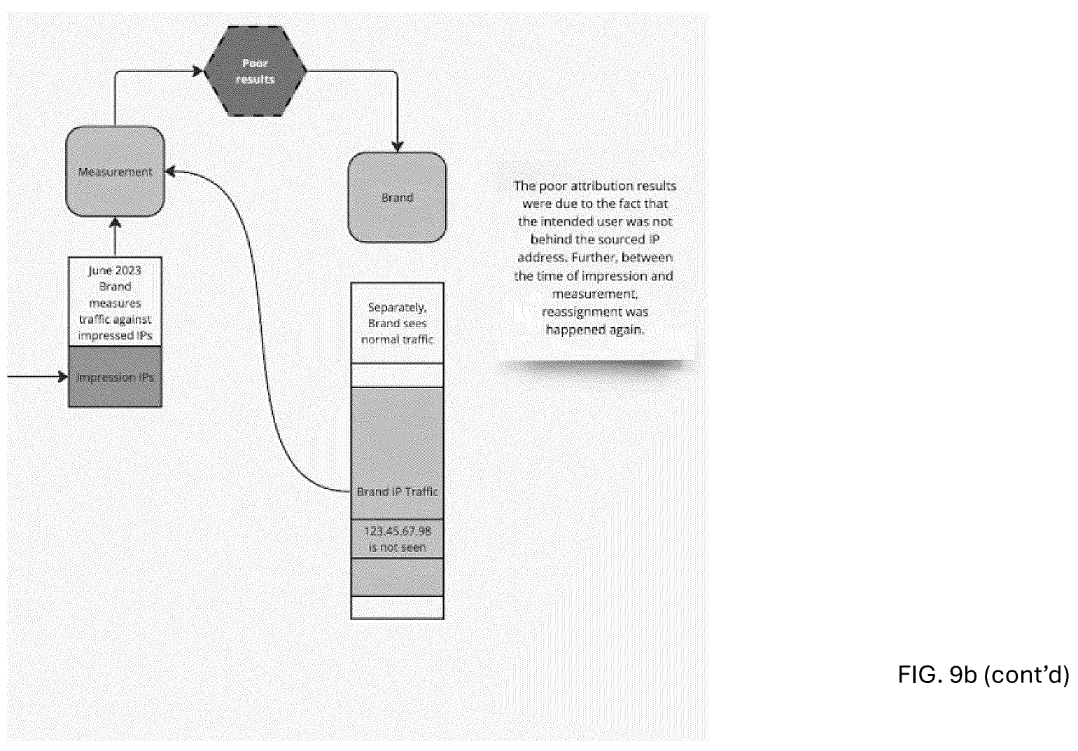

LocationID in the context of IP Based Audience Segments: In one instance, the system is configured to provide audience segmentation. FIG. 9 illustrates an example ad platform in accordance with embodiments of the present disclosure Advertising is very dependent on the practice of segmentation, be it for behavioral, psychographics, etc., —in B2C and B2B spaces. The practice of segmentation is not strictly reserved for audience segmentation and targeting but it is a primary use case.

When an ad auction processes a bid request, it enriches the received data. For TP addresses, the system will resolve the geolocation information, and check for match segments, where the system queries a database.

A sample Audience segment using TP Addresses:

Segment: Males, HoH, 150k+ (ID 12345)

27.22.245.251
36.144.190.12

| IP Address | Segment ID |
|---|---|
| 27.22.245.251 | 12345 |
| 36.144.190.12 | 12345 |

Segments are then further organized to include many segments:

| IP Address | Segment ID |
|---|---|
| 27.22.245.251 | 12345 |
| 27.22.245.251 | 30394 |

| Segment name | Segment ID |
|---|---|
| Segment: Males, HoH, 150k+ | 12345 |
| Segments: Females, HoH, 200K+ | 30394 |

A sample Audience segment using IP Addresses:

This new breakdown lets the ad server now target segments efficiently:
Human Interface for Campaign A:
Human Assigns Include Segments: Males, HoH, 150 k+
Data is stored as Campaign A, Segments 12345

When the IP (e.g. 27.22.245.25I) in the bid request is enriched, the auction performs a lookup against 27.22.245.25I and it returns 12345, 30394.

The auction then looks for any campaigns that are targeting 12345 or 30394, if they are, then they can continue evaluating other parameters of the targeting. The final ads are then sent back to the source of the request as the bid response. This is a standard process with variations of implementation details.

Segments all come from various sources, and they generally have some frequency of updates but there is no set rule. For instance, in data segmentation full refreshes are less common than incremental updates. A full refresh requires someone to delete the entire segment from the data platform and load new data, which can often be excessive for a few changed/new records. Cheaper implementations use incremental updates which add new records but do not delete old ones. It's very easy for data to become stale and not leave or become modified beyond general-purpose expiration policies. This creates an often-ignored problem where IP (and other records) are updated far from real-time, and it works in cases where data doesn't change often, such as demographics.

IP volatility is disconnected from this process and there are no alarm bells in place to notify a data aggregator of the change. For instance, as shown in FIG. 9:
In January 2023, a user's IP address is collected from a business reselling info to 3rd parties. The gender, home ownership and HouseHold Income is collected and aggregated into a larger segment of IP.
The segment is then added to a campaign targeting in Feb 2023
The campaign goes live in March 2023.
The Impressions are delivered through the end of April 2023
The Measurement company compares Brand website traffic IP addresses to those of the impressions delivered, which is a direct subset of the targeted audience.

In such a scenario, the IP addresses being served an ad, and the IP addresses being measured are assumed to be the same users as when it was added to the segment in January, which is problematic. As any of the targeted IP addresses are reallocated from one building to another, the IPs being impressed or measured might look the same on a report, but they will be different users, and they will yield results that widely vary from the expectation.

This process applies to all IP connectivity, be it segments, or IP Geo resolution. In the same vein, the more granular the IPGeo classification, the more volatile it will be. IP Reallocation happens at different scales, but even moderate distances are more likely to leave a postal code than a city, so until the IPGeo record is updated, a volatile IP address will render the associated location incorrect.

To resolve the above issues, location identifiers as described herein are a geospatial, stationary values. As the system monitors the IP < > LocationID association, it does so over a period of time. Where an IP address is used as a proxy to location, what matters is the stability of that identifier.

If the same process were to be conducted with segments of Location ID, the ID would not change while the IPs would.

For instance, the system records for IP 27.22.245.25I, the month over month IP associations might be:

| January | February | March | April | May | June |
|---|---|---|---|---|---|
| 12345678 | 12345678 | 27384828 | 27384828 | 29399290 | 29399290 |

This time, when the DSP is serving impressions in March to 27.22.245.25I, they could query for the LocationID value and we would return the historical records, which would show the LocationIDs that this IP has belonged to as it hopped around, and they can focus on the date that the IP records were sourced: January—with Location ID 12345678.

Now, instead of targeting IP address in the bidstream, they would look for the Location ID being sent by a Publisher. In this case, the Publisher would be resolving the Location ID from a new IP, for instance 87.54.21.01. The DSP is then able to deliver ads to the Publisher regardless of volatility because Location ID has bridged time:
Publisher IP, June: 87.54.21.01>Location ID 12345678
OpenRTB Bid Request User Object now includes 12345678
DSP: March lookup: 27.22.245.25I>Location ID 12345678
DSP now targets the OpenRTB bid Request user Object looking for 12345678
Location ID has now facilitated the match of 27.22.245.25I and 87.54.21.01 using Location IDs lookback window.

### Example Method

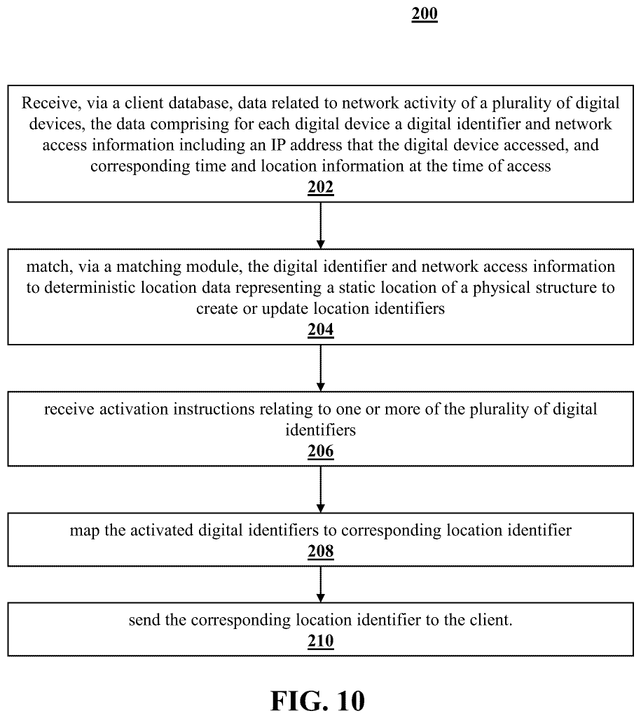

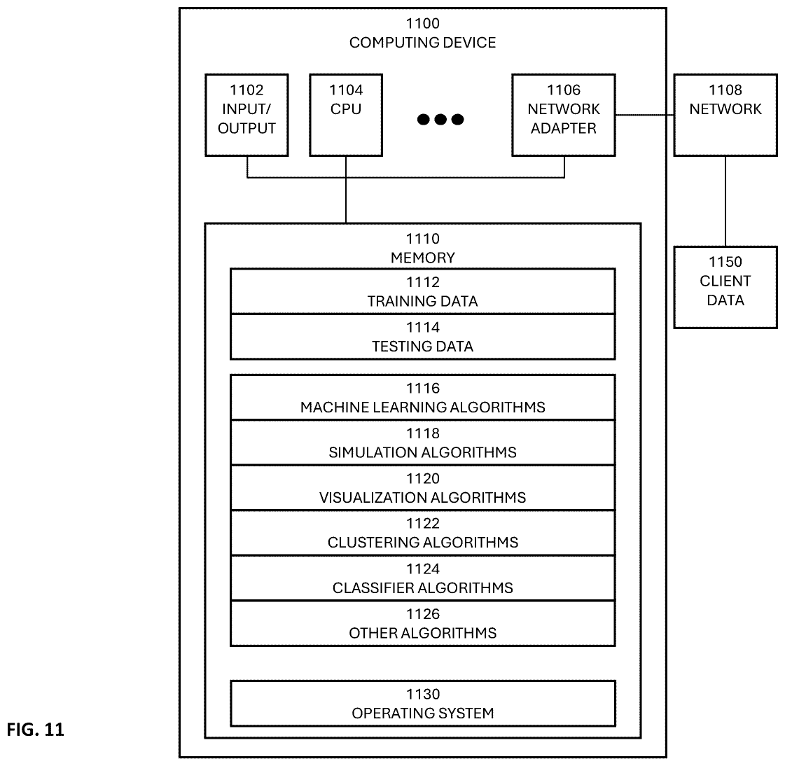

FIG. 10 is a flowchart of an example process 200 according to an aspect of the present disclosure. In some implementations, one or more process blocks of FIG. 10 may be performed by a computing device or system (e.g., see FIG. 11). As shown in FIG. 10, the process 200 may include receiving, via a client database, data related to network activity of a plurality of digital devices, the data having for each digital device: a digital identifier; and network access information including an IP address that the digital device accessed, and corresponding time and location information at the time of access (block 202). From here, the process can match, via a matching module, the digital identifier and network access information to deterministic location data representing a static location of a physical structure to create or update location identifiers (block 204). Next, the location identifier process 200 may include receiving activation instructions relating to one or more of the plurality of digital identifiers (block 206). From here, mapping the activated digital identifiers to corresponding location identifiers can occur (block 208). Last, the method can include sending the location identifier to the client (block 210).

The location identification process can include additional implementations, such as any single implementation or any combination of implementations described below and/or in connection with one or more other processes described elsewhere herein. In a first implementation, the deterministic location data may include a latitude and longitude of the physical structure. In a second implementation, alone or in combination with the first implementation, the digital identifier is an IP address, a mobile ad ID, a connected TV ID, or an email address. In a third implementation, alone or in combination with the first and second implementation, the mapping step activates the location identifier. In a fourth implementation, alone or in combination with one or more of the first through third implementations, the matching step further may include adding context data to the location identifier. In a fifth implementation, alone or in combination with one or more of the first through fourth implementations, the activation instructions are received from an advertiser platform. In a sixth implementation, alone or in combination with one or more of the first through fifth implementations, the digital identifier data is embedded in a streaming platform.

In a seventh implementation, alone or in combination with one or more of the first through sixth implementations, the location identifiers include the deterministic location data, the IP address, and digital identifiers that accessed the IP address at the deterministic location data. In an eighth implementation, alone or in combination with one or more of the first through seventh implementations, the location identifiers further comprise access time of the digital identifier. In a ninth implementation, alone or in combination with one or more of the first through eighth implementations, the activation instructions further include a time component, wherein the mapping step further comprises including using the time component to map to the access time of the digital identifiers to identify the corresponding location identifiers. In a tenth implementation, alone or in combination with one or more of the first through ninth implementations, the IP address can include a plurality of IP addresses. In an eleventh implementation, alone or in combination with one or more of the first through tenth implementations, the corresponding location identifier comprises multiple location identifiers.

Although FIG. 10 shows example blocks of process 200, in some implementations, process 200 may include additional blocks, fewer blocks, different blocks, or differently arranged blocks than those depicted in FIG. 10. Additionally, or alternatively, two or more of the blocks of process 200 may be performed in parallel.

The present disclosure includes at least the following aspects:

Aspect 1: A method for location identification comprising: receiving, via a client database, data related to network activity of a plurality of digital devices, the data comprising for each digital device: a digital identifier; and network access information including an IP address that the digital device accessed, and corresponding time and location information at the time of access; ii. matching, via a matching module, the digital identifier and network access information to deterministic location data representing a static location of a physical structure to create or update location identifiers; iii. receiving activation instructions relating to one or more of the plurality of digital identifiers; iv. mapping the activated digital identifiers to corresponding location identifier; and v. sending the corresponding location identifier to the client.

Aspect 2: The method of aspect 1, wherein the deterministic location data comprises a latitude and longitude of the physical structure.

Aspect 2: The method of any of aspects 1-2, wherein the digital identifier is an IP address, a mobile ad ID, a connected TV ID, or an email address.

Aspect 4: The method of any of aspects 1-3, wherein the mapping step activates the location identifier.

Aspect 5: The method of any of aspects 1-4, wherein the matching step further comprises adding context data to the location identifier.

Aspect 6: The method of any of aspects 1-5, wherein the activation instructions are received from an advertiser platform.

Aspect 7: The method of any of aspects 1-6, wherein the digital identifier data is embedded in a streaming platform.

Aspect 8: The method of any of aspects 1-7, wherein the location identifiers include the deterministic location data, the IP address, and digital identifiers that accessed the IP address at the deterministic location data.

Aspect 9: The method of any of aspect 8, wherein the location identifiers further comprise access time of the digital identifier.

Aspect 10: The method of any of aspect 9, wherein the activation instructions further include a time component, wherein the mapping step further comprises including using the time component to map to the access time of the digital identifiers to identify the corresponding location identifiers.

Aspect 11: The method of any of aspects 1-10, wherein the IP address can include a plurality of IP addresses.

Aspect 12: The method of claim any of aspects 1-11, wherein the corresponding location identifier comprises multiple location identifiers.

Aspect 13: A system for location identification comprising one or more processors configured to:
a. receive, via a client database, data related to network activity of a plurality of digital devices, the data comprising for each digital device:
   i. a digital identifier; and
   ii. network access information include an IP address that the digital device accessed, and corresponding time and location information at the time of access;
b. match, via a matching module, the digital identifier and network access information to deterministic location data representing a static location of a physical structure to create or update location identifiers;
c. receive activation instructions relating to one or more of the plurality of digital identifiers;
d. map the activated digital identifiers to corresponding location identifiers; and
e. send the location identifier to the client.

Aspect 14: The system of aspect 13, wherein the deterministic location data comprises a latitude and longitude of the physical structure and the digital identifier is an IP address, a mobile ad ID, a connected TV ID, or an email address.

Aspect 15: The system of any of aspects 13-14, wherein the one or more processors is further configured to add context data to the location identifier.

Aspect 16: The system of any of aspects 13-15, wherein the location identifiers include the deterministic location data, the IP address, the digital identifiers that accessed the IP address at the deterministic location data, and the access time of the digital identifier.

Aspect 17: The system of any of aspects 13-16, wherein the activation instructions further include a time component, wherein the processor is further configured to include using the time component to map to the access time of the digital identifiers to identify the corresponding location identifiers.

Aspect 18: The system of any of aspects 14-16, wherein the IP address can include a plurality of IP addresses.

Aspect 19: A non-transitory computer-readable medium storing a set of instructions for location identification, the set of instructions comprising:
one or more instructions that, when executed by one or more processors of a device, cause the device to:
   receive, via a client database, data related to network activity of a plurality of digital devices, the data comprising for each digital device a digital identifier and network access information that includes an IP address that the digital device accessed, and corresponding time and location information at the time of access, wherein the digital identifier includes an IP address, a mobile ad ID, a connected TV ID, or an email address;
   match, via a matching module, the digital identifier and network access information to deterministic location data representing a static location of a physical structure to create or update location identifiers, the deterministic location data comprising a latitude and a longitude of the physical structure;
   receive activation instructions relating to one or more of the plurality of digital identifiers;
   map the activated digital identifiers to corresponding location identifiers; and
   send the location identifier to the client.

Aspect 20: The non-transitory computer-readable medium of aspect 19, wherein the location identifiers further comprise access time of the digital identifier and the activation instructions further include a time component, wherein the mapping step further comprises including using the time component to map to the access time of the digital identifiers to identify the corresponding location identifiers.

The above system and methods provide many advantages over currently available systems. First, identity resolution for analytics and targeting is more complex now than ever. Second, privacy compliance is becoming more difficult as regulation is fragmented by geography. In addition, third party data is becoming more and more scarce. Further, consumer experience has to be over multiple channels. And lastly, there is a need to protect user data from being reidentified to the person. The system as described above provides these advantages.

The present systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

FIG. 11 illustrates a computing device 1100 as it relates to the present disclosure. The computing device 1100 may, for example, perform calculations, execute routines and algorithms, process data, communicate with other devices via a network, and display results. For example, a computing device 1100 may comprise a processor or CPU 1104, a network adapter 1106 for communication with a network 1108. The network 1108 may connect the computing device 1100 to external data sources such as patient data 1150 or to other computers (not shown in the figure). The computing device may comprise an input/output device 1102. Such an input/output component 1102 may be an input device, an output device, or both and the computing device 1100 may have several such components. Example input devices 1102 include a keyboard, a mouse, a microphone, a touchpad, a joystick, and the like. Example output devices 1102 include a display, a speaker, a haptic feedback device, and the like. The computing device 1100 may further comprise memory 1110 or a computer readable storage medium 1110. In the computer memory 1110 may reside instructions for carrying out the methods and techniques described elsewhere in this disclosure. The computer memory 1110 may also comprise an operating system 1130 for control of the various parts and components of the computing device 1100. The memory 1110 may also store data, for example training data 1112 and testing data 1114, or other data (not shown in the figure). The memory 1110 may also comprise algorithms such as machine learning algorithms 1116, simulation algorithms 1118, visualization algorithms 1120, clustering algorithms 1122, classifier algorithms 1124, or other algorithms 1126.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network 1108, for example, the Internet, a local area network, a wide area network and/or a wireless network. The network 1108 may comprise copper transmission cables, optical transmission fibers, wireless transmission, routers, firewalls, switches, gateway computers, and/or edge servers. A network adapter card 1106 or network interface in each computing/processing device 1100 receives computer readable program instructions from the network 1108 and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or that carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for location identification comprising:
a. receiving, via a client database, data related to network activity of a plurality of digital devices, the data comprising for each digital device:
i. a digital identifier; and
ii. network access information including an IP address that the digital device accessed, and corresponding time and location information at the time of access;
b. matching, via a matching module, the digital identifier and network access information to deterministic location data representing a static location of a physical structure to create or update location identifiers;
c. receiving activation instructions relating to one or more of the plurality of digital identifiers;
d. mapping the activated digital identifiers to corresponding location identifier; and
e. sending the corresponding location identifier to the client.

2. The method of claim 1, wherein the deterministic location data comprises a latitude and longitude of the physical structure.

3. The method of claim 1, wherein the digital identifier is an IP address, a mobile ad ID, a connected TV ID, or an email address.

4. The method of claim 1, wherein the mapping step activates the location identifier.

5. The method of claim 1, wherein the matching step further comprises adding context data to the location identifier.

6. The method of claim 1, wherein the activation instructions are received from an advertiser platform.

7. The method of claim 1, wherein the digital identifier data is embedded in a streaming platform.

8. The method of claim 1, wherein the location identifiers include the deterministic location data, the IP address, and digital identifiers that accessed the IP address at the deterministic location data.

9. The method of claim 8, wherein the location identifiers further comprise access time of the digital identifier.

10. The method of claim 9, wherein the activation instructions further include a time component, wherein the mapping step further comprises including using the time component to map to the access time of the digital identifiers to identify the corresponding location identifiers.

11. The method of claim 8, wherein the IP address can include a plurality of IP addresses.

12. The method of claim 1, wherein the corresponding location identifier comprises multiple location identifiers.

13. A system for location identification comprising one or more processors configured to:
a. receive, via a client database, data related to network activity of a plurality of digital devices, the data comprising for each digital device:
i. a digital identifier; and
ii. network access information include an IP address that the digital device accessed, and corresponding time and location information at the time of access;
b. match, via a matching module, the digital identifier and network access information to deterministic location data representing a static location of a physical structure to create or update location identifiers;
c. receive activation instructions relating to one or more of the plurality of digital identifiers;
d. map the activated digital identifiers to corresponding location identifiers; and
e. send the location identifier to the client.

14. The system of claim 13, wherein the deterministic location data comprises a latitude and longitude of the physical structure and the digital identifier is an IP address, a mobile ad ID, a connected TV ID, or an email address.

15. The system of claim 13, wherein the one or more processors is further configured to add context data to the location identifier.

16. The system of claim 13, wherein the location identifiers include the deterministic location data, the IP address, the digital identifiers that accessed the IP address at the deterministic location data, and the access time of the digital identifier.

17. The system of claim 13, wherein the activation instructions further include a time component, wherein the processor is further configured to include using the time component to map to the access time of the digital identifiers to identify the corresponding location identifiers.

18. The system of claim 14, wherein the IP address can include a plurality of IP addresses.

19. A non-transitory computer-readable medium storing a set of instructions for location identification, the set of instructions comprising:
one or more instructions that, when executed by one or more processors of a device, cause the device to:
receive, via a client database, data related to network activity of a plurality of digital devices, the data comprising for each digital device a digital identifier and network access information that includes an IP address that the digital device accessed, and corresponding time and location information at the time of access, wherein the digital identifier includes an IP address, a mobile ad ID, a connected TV ID, or an email address;
match, via a matching module, the digital identifier and network access information to deterministic location data representing a static location of a physical structure to create or update location identifiers, the deterministic location data comprising a latitude and a longitude of the physical structure;
receive activation instructions relating to one or more of the plurality of digital identifiers;
map the activated digital identifiers to corresponding location identifiers; and
send the location identifier to the client.

20. The non-transitory computer-readable medium of claim 19, wherein the location identifiers further comprise access time of the digital identifier and the activation instructions further include a time component, wherein the mapping step further comprises including using the time component to map to the access time of the digital identifiers to identify the corresponding location identifiers.
